(19) United States
(12) Patent Application Publication
(10) Pub. No.: US 2003/0056141 A1
(43) Pub. Date: Mar. 20, 2003

(54) Control method used in and-gate type system to increase efficiency and lengthen lifetime of use

(76) Inventors: Chen Nan Lai, Hsinchu (TW); Yao Ze Cheng, Hsinchu (TW); Chuan Sheng Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/953,873

(22) Filed: Sep. 18, 2001

(51) Int. Cl. H04L 1/22

(52) U.S. Cl. 714/6

(57) ABSTRACT

The present invention relates to a flash memory and, more particularly, to an and-gate type flash memory, wherein a plurality of data storage units are provided, each of the data storage units is partitioned into a plurality of sectors, and an ECC data directly abuts behind each of the sectors to store the ECC of the sector, thereby shortening the access time of data when the data storage unit is not filled. At least a dynamic spare storage unit not detectable by a mainframe is provided in the data storage unit. When a sector of a flash memory is damaged, a control device is used to store the data in the damaged storage unit into the dynamic spare storage unit, thereby decreasing the number of damaged storage units detectable by the mainframe to relatively lengthen the lifetime of use of the flash memory.

### FIELD OF THE INVENTION

The present invention relates to a flash memory and, more particularly, to an and-gate type flash memory, wherein an error-correcting code (ECC) data correspondingly recording the ECC of a sector directly abuts behind each sector, thereby decreasing data access time when a data storage unit is not filled.

### BACKGROUND OF THE INVENTION

Along with continual progress of information industry, high-speed data storage devices (memories) will play an important role due to influence of faster and faster CPUs and emergence of IA products. Among various kinds of data storage devices, flash memories are widely expected because of their characteristics of non-volatility and easy change and access of data.

FIG. 1 is a structure diagram of a general flash memory storage system, wherein a plurality of flash memories 11˜19 are connected to a mainframe 29 via a control device 20. The control device 20 comprises a microprocessor 25 therein, which can be connected to the mainframe 29 via a mainframe interface controller 24 conforming to protocols of PCMCIA, IDE, ATA, MMC, SD, compact flash, or their combinations. One end of the microprocessor 25 is connected to a plurality of and-gate type flash memories 11˜19.via a control logical circuit 26. Another end of the microprocessor 25 is connected to a stack controller 22 capable of controlling the action of temporarily storing a data to be accessed in a data stack. Additionally, an ECC logical circuit 23 is respectively connected to the microprocessor 25, the stack controller 22, and the storage control logical circuit 26. The ECC logical circuit 23 is controlled by the microprocessor 25 to give a corresponding ECC to a sector to be accessed.

When the mainframe 29 informs there are data or instructions to be stored, the microprocessor 25 and the storage control logical circuit 26 are exploited to inform corresponding flash memories 11˜19 to prepare the action of storing data. Simultaneously, the data to be stored are stored in registers 211 and 213 of a data stack 21 through the control of the microprocessor 25 and the stack controller 22. When a first flash memory 31 has finished relevant preparations, the microprocessor 25 and the storage control logical circuit 26 are exploited to store the data temporarily stored in the data stack 21 into the first flash memory 31. After the data have been stored, the microprocessor 25 is informed. The microprocessor 25 will continues to send following data which remained in memory stack to first flash memory 11 the sent data's location address enclosed by one flash memory. The above steps are repeated until all data are completely stored. Such that, logical data-location address are continues in one flash memory in prior art.

Although a prior art flash memory storage system can achieve the effect of accessing data of a plurality of flash memories, the transmission protocol thereof still follows the sequence of informing the memory to prepare access of a first data, accessing the first data, informing completion of access of the first data, informing the memory to prepare access of a second data, and so on. Because the work time of accessing data is much larger than the time of informing action of instruction, the control devices 20 such as the mainframe 29 and the microprocessor 25 will have long idle time, hence being not efficiently used.

Moreover, FIG. 2 is a structural allocation diagram of a prior art and-gate type flash memory. A plurality of data storage units B1, B2˜Bm+2 are partitioned in an and-gate type flash memory 11, and each data storage unit (e.g., B1) is further partitioned into a plurality of sectors D1, D2, D3, and D4. ECC data E1˜E4 are arranged after the sectors D1˜D4 to record ECCs of corresponding sectors D1˜D4, respectively. The data storage unit can be roughly divided into two types according to design, one being detectable unit range B1˜Bm, which can be detected and recorded by the mainframe 29; the other being static spare storage unit range Bm+1˜Bm+2, which cannot be detected by the mainframe 29. When a flash memory leaves the factory and is to store data, it will self-detect. If there is any data storage unit (B1˜Bm) in the detectable unit range damaged, one data storage unit (Bm+1) in the static spare storage unit range is used as a corresponding alternate storage unit. Therefore, when the mainframe 29 is to access the damaged storage unit (B2), the control device will automatically switch to the alternate data storage unit (Bm+1).

Although the prior art and-gate type flash memory can detect and rectify the correctness of accessed data at any time through the help of the ECC data, the corresponding ECC data E1˜E4 are read after data in the sectors D1˜D4 have been sequentially read in each time of access action. If not all the sectors D1˜D4 in the data storage unit (B1) store data, it is still necessary to perform the action in this sequence. In other words, the relevant ECC data can be read after at least one action of reading a blank sector, hence decreasing the operational time of the and-gate type flash memory.

In addition, if one sector or a data storage unit (B1) 111 of a prior art and-gate type flash memory is damaged, it is necessary to inform the mainframe 29 of the position of the damaged storage unit (B1). The mainframe 29 will try at its best to retrieve the data previously stored in the damaged storage unit (B1) 111, and find some blank data storage unit (BL) 117 in the detectable unit range to recover the original data. The mainframe 29 will be informed of the addresses of the damaged storage unit (B1) 111 and the corresponding alternate storage unit (BL) 117. The damaged storage unit (B1) 111 cannot be used any more. However, a general mainframe cannot preclude all damaged storage units, hence resulting in remediless disturbance.

Along with continual use of the memory, the number of damaged storage units thereof will continually increase. When the number of damaged storage units, which can be detected or recorded by a mainframe, exceeds a certain value, or the damaged storage units store system data such as the FAT and the partition table, the memory cannot be used any more. Therefore, how to decrease the number of damaged storage units, which can be detected or recorded by a mainframe, and how to retrieve damaged data as soon as possible are keys of lengthening the lifetime of use of the memory.

Accordingly, the present invention aims to provide a novel and-gate type flash memory to save access time of data and length the lifetime of use thereof.

### SUMMARY OF THE INVENTION

The primary object of the present invention is to provide an and-gate type flash memory, wherein each data storage unit thereof is partitioned into a plurality of sectors, and an ECC data directly abuts behind each of the sectors to store the ECC of the sector to detect or rectify the correctness of sectors in the most direct and fastest way, thereby not only achieving the object of detecting and rectifying data, but also saving access time of data.

The secondary object of the present invention is to provide an and-gate type flash memory, wherein a dynamic spare storage unit not detectable by the mainframe is provided. When a data storage unit of a memory is damaged, a blank storage unit in the dynamic spare storage unit is used as an alternate storage unit, thereby decreasing the number of damaged storage units, which can be detected or recorded by the mainframe, to relatively lengthen the lifetime of use of the flash memory.

Another object of the present invention is to provide an and-gate type flash memory and an operational method thereof, wherein a microprocessor thereof can partition data to be accessed into a plurality of sectors, and effectively operate the partitioned data between a data stack and a plurality of memories in interleaving way, thereby shortening the access time of data.

The various objects and advantages of the present invention will be more readily understood from the following detailed description when read in conjunction with the appended drawing, in which:

### BRIEF DESCRIPTION OF THE DRAWINGS

FIG. 1 is a structure diagram of a general flash memory storage system;

FIG. 2 is a structural allocation diagram of a prior art and-gate type flash memory;

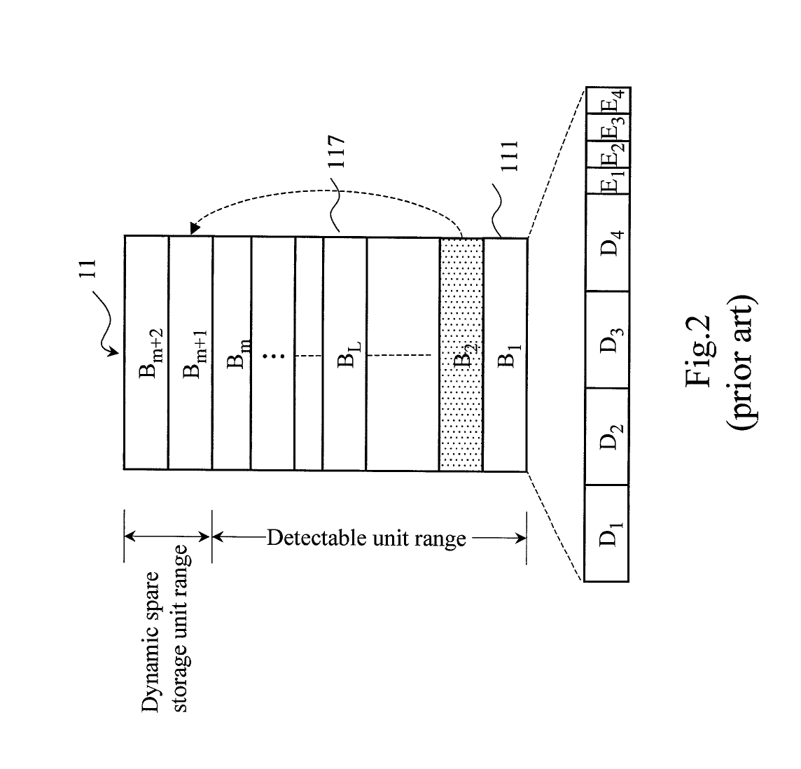

FIG. 3 is a structural allocation diagram of an and-gate type flash memory according to a preferred embodiment of the present invention; and

FIGS. 4A to 4C are operational flowcharts of the present invention when storing data.

### DETAILED DESCRIPTION OF THE PREFERRED EMBODIMENTS

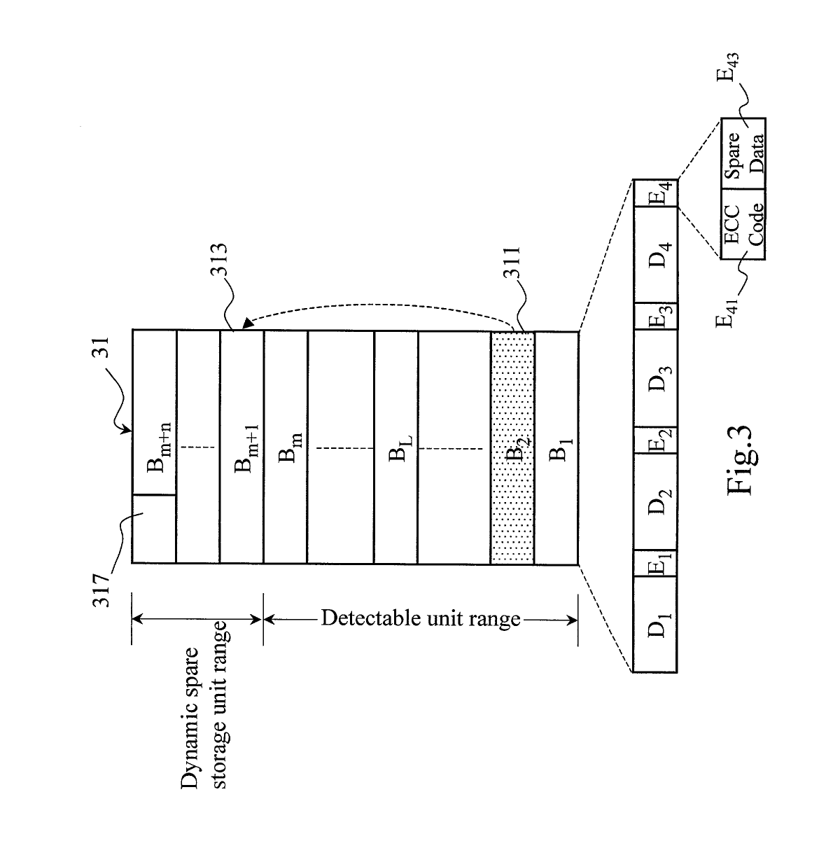

As shown in FIG. 3, an and-gate type flash memory 31 of the present invention is partitioned into a plurality of data storage units B1, B2˜Bm, Bm+1˜Bm+n. Each data storage unit (B1) is further partitioned into a plurality of sectors D1, D2, D3, D4 and ECC data E1, E2, E3, E4 capable of recording ECCs of the corresponding sectors D1˜D4. The ECC data (E1) directly abuts behind the corresponding sector (D1). When a mainframe 29 is to access data, it can read the data of the corresponding ECC data (E1) immediately after reading the data of the sector (D1). Therefore, the mainframe 29 can truly reflect the operational time according to the data storage condition of the sector in the data storage unit (B1), and will not waste the time of reading blank sectors as a prior art flash memory so as to successfully read the data in the ECC data (E1). Therefore, the operational time thereof can be greatly shortened.

Moreover, the data storage units of the and-gate type flash memory of the present invention are divided into a detectable unit range (B1, B2˜Bm), which can be detected or recorded by the mainframe 29, and a dynamic storage unit range (Bm+1˜Bm+n), which cannot be detected or recorded by the mainframe 29. The data storage units (B1, B2˜Bm) in the detectable unit range can normally store data as a prior art flash memory. However, when a data storage unit (B2) 311 or a sector thereof is damaged, the microprocessor 25 of the control device 20 will automatically detect the damaged storage unit and immediately find out the damaged sector, and dynamically store the data in the damaged storage unit 311 into a blank spare storage unit (Bm+1) 313 in the dynamic spare storage unit range. Therefore, data can be immediately retrieved so that there is no disturbance of loss of data. The probability of damage of the data storage units (B 1, B2˜Bm) in the detectable unit range can also be reduced. Of course, the number of damaged storage units the mainframe 29 can detect or record can be relatively decreased, hence lengthening the lifetime of use of the flash memory.

Additionally, the data storage units (Bm+1˜Bm+n) in the dynamic spare storage unit range of the present invention can also be used as alternate storage units when there is a damaged storage unit self-detected. In other words, the data storage units (Bm+1˜Bm+n) have the function of the prior art static spare storage units and can also achieve the object of dynamic alternate storage units.

Relevant address data of the damaged storage unit 311 and the corresponding spare storage unit 313 can be recorded into a condition table 317 located in some special storage units. This table records the using status of each storage unit. Because the condition table 317 should be detected at booting and corresponds to a control device, the data storage unit of the condition table 317 should be limited to some special non-detectable units in spare unit range.

Moreover, in addition to having an ECC code E41 capable of recording ECC, the ECC data (E4) of the present invention can also have a spare data E43 capable of recording whether the sector (D4) can normally operate and relevant address data of the alternate storage units or the alternate sector address in case of damaged unit.

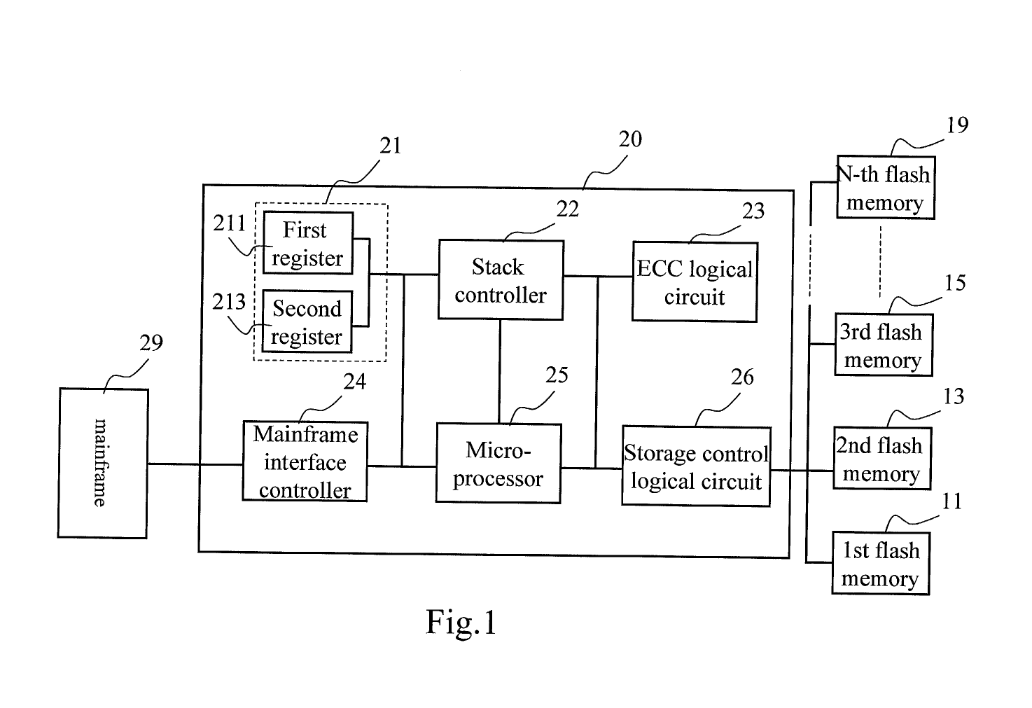

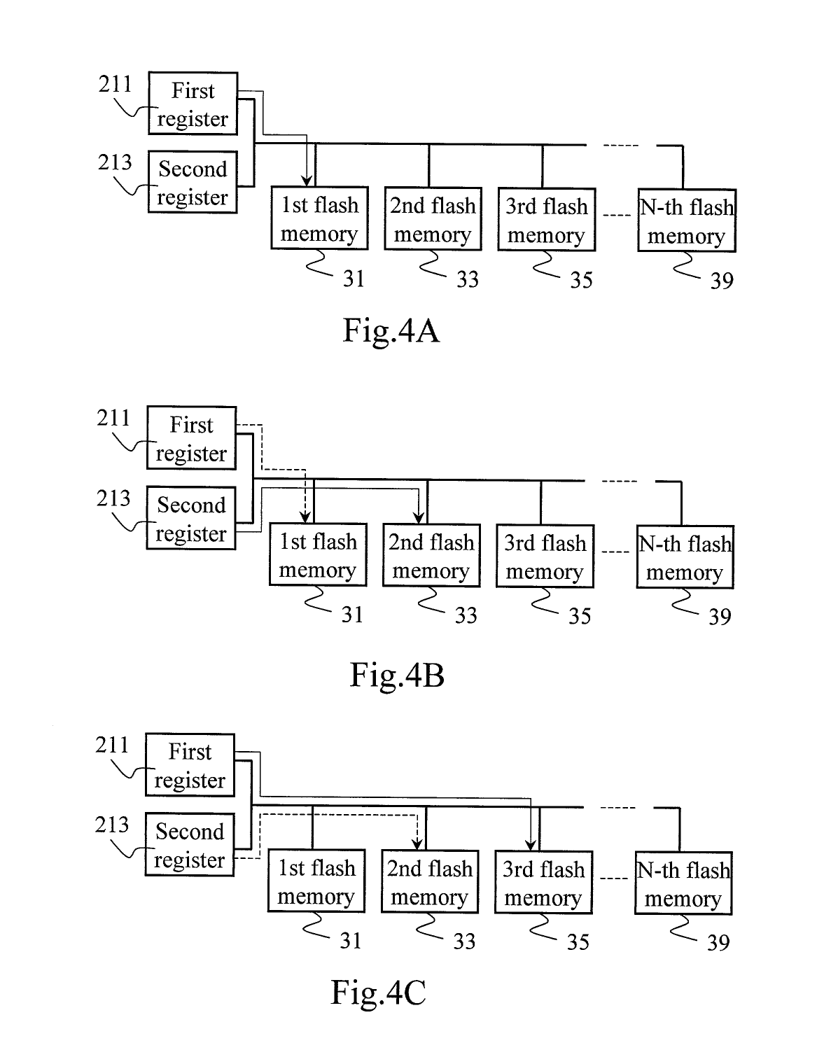

Finally, please refer to FIG. 1 and FIGS. 4A to 4C. The present invention makes use of a control device 20 as a relay control device between the mainframe 29 and a plurality of flash memories 31˜39. The control device 20 similarly comprises a mainframe interface controller 24, a microprocessor 25, a stack controller 22, at least a data stack 21 (211, 212), an ECC logical circuit 23, and a storage control logical circuit 26. The functions and objects of disposition thereof are the same as those of a prior art flash memory system.

When the mainframe 29 informs there are data or instructions to be stored, the mainframe interface controller 24, the microprocessor 25, and the storage control logical circuit 26 are exploited to inform the corresponding flash memories 31˜39 to prepare the actions of storing data. Simultaneously, the data to be stored can be partitioned and stored into the registers 211 and 213 of the data stack 21 through the functions of the mainframe interface controller 24, the microprocessor 25, and the stack controller 22. When the first flash memory 31 has finished relevant preparations, the microprocessor 25, the stack controller 22, the ECC logical circuit 23, and the storage control logical circuit 26 are exploited to store the data temporarily stored in the first register 211 into the first flash memory 31, as shown in FIG. 4A.

In transmission of computer data, the access time of data is much larger than the communication time of instruction. In order to save the idle time of the mainframe 29 to increase the operational speed thereof, the present invention adopts an interleaving-address access mode. In other words, when the first flash memory 31 is still in the action of storing data, the microprocessor 25 and the storage control logical circuit 26 already achieve communication of protocol with the second flash memory 33, and start to transfer the temporary data in the second register 213 to the second flash memory 33, as shown in FIG. 4B.

When the data temporarily stored in the first register 211 has been transferred to the first flash memory 31, the microprocessor 25 and the storage control logical circuit 26 already achieve communication of protocol with the third flash memory 35. When there is data temporarily stored in the first register 211, the data can be immediately transferred to and stored in the third flash memory 35. Simultaneously, the first flash memory 31 or the second flash memory 33 may still in the step of storing data, as shown in FIG. 4C.

The present invention makes use of this interleaving-address storage mode to achieve the object of fast operation, greatly decreasing the idle time of the mainframe 29. Of course, when the mainframe 29 informs to read data, the same interleaving-address mode can also be followed to achieve the effect of fast operation.

To sum up, the present invention relates to a flash memory and, more particularly, to an and-gate type flash memory, wherein an ECC data directly abuts behind each sector to store the ECC of the sector to shorten the access time of data when the data storage unit is not filled. Moreover, dynamic spare storage units, which cannot be detected and recorded by the mainframe, are provided in the memory to dynamically store data in damaged data storage units, thereby lengthening the lifetime of use of the memory.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

We claim:

1. An and-gate type flash memory having a plurality of data storage units partitioned therein, each of said data storage units being further partitioned into a plurality of sectors, a corresponding ECC data abutting behind each of said sectors to record ECC of said sector.

2. The and-gate type flash memory as claimed in claim 1, wherein said ECC data can further comprise a spare data.

3. The and-gate type flash memory as claimed in claim 1, wherein said data storage units can further have at least a dynamic spare storage unit, which cannot be detected by a mainframe.

4. The and-gate type flash memory as claimed in claim 1, wherein said data storage units can further have condition tables.

5. An and-gate type flash memory having a plurality of data storage units partitioned therein, said data storage units having at least a dynamic spare storage unit, which cannot be detected by a mainframe, said dynamic spare storage unit being used to store data stored in a damaged data storage unit when one of said data storage units is damaged after said memory leaves the factory and is used.

6. The and-gate type flash memory as claimed in claim 5, wherein said dynamic spare storage unit can also be used as an alternate storage unit when said memory leaves the factory and self-detects that one of said data storage units is damaged.

7. An operational method applicable to the and-gate type flash memory as claimed in claim 5, comprising the steps of:
controlling access actions between a mainframe and said memory by a control device; and
immediately storing data stored in a damaged storage unit into a dynamic spare storage unit not detectable by said mainframe when data is damaged during the access actions.

8. The operational method as claimed in claim 7, wherein said control device has at least a data stack therein, said control device being connected to a plurality of flash memories via a microprocessor, data to be accessed being partitioned into a plurality of sectors to be transferred between said data stack and corresponding memories in interleaving way through control of said microprocessor when said mainframe is to access data.

9. The operational method as claimed in claim 8, wherein said data stack has a plurality of registers therein to respectively store corresponding partitioned sectors.
